(19) United States
(12) Patent Application Publication
(10) Pub. No.: US 2008/0170414 A1
(43) Pub. Date: Jul. 17, 2008

(54) LED backlight module for an LCD device

(75) Inventor: Tsun-I Wang, Taoyuan Hsien (TW)

Correspondence Address: BIRCH STEWART KOLASCH & BIRCH, PO BOX 747, FALLS CHURCH, VA, 22040-0747, US

(73) Assignee: DYNASCAN TECHNOLOGY CORP.

(21) Appl. No.: 12/003,177

(22) Filed: Dec. 20, 2007

(30) Foreign Application Priority Data
Jan. 15, 2007 (TW) 096101464

(51) Int. Cl. F21V 8/00

(52) U.S. Cl. 362/612

(57) ABSTRACT

An LED backlight module comprises a light-guide plate having at least one light-emit surface and a light-guide bar extended from one side of the light-guide plate, the thickness of the light-guide plate is smaller than the diameter of the light-guide bar, wherein the light-guide bar has at least one incident inlet, an LED module is disposed at the light-guide bar and corresponds to said incident inlet, light from a single LED enters into the light-guide bar via the incident inlet, then the light is totally reflected, and partial light is introduced into the light-guide plate firstly, other light is guided forward to the light-guide plate by way of curing, therefore the light is guided into the whole light-guide bar along z-axis so as to form the slim backlight module with good uniformity.

### FIELD OF THE INVENTION

The invention relates to a backlight module, and more particularly to a backlight module of an LCD, the backlight module is capable of disposing an LED at an incident inlet of a light-guide bar in order to effectively induce light into a slim light-guide plate.

### BACKGROUND OF THE INVENTION

The backlight module of an old fashion LCD applies a CCFL (cold cathode fluorescent lamp) to broadside emit light into the end surface of a light-guide plate. Nowadays, the manufacturers of laptop computers use LEDs (Light Emitting Diode) as light sources in the backlight modules instead of CCFLs so as to lower the power consumption and the total volume of such laptop computers. Due to that of the thickness of the light-guide plate of the backlight module of a slim laptop computer being within 1 mm or even around 0.5 mm in some cases, therefore the thickness of the light-emit surface of the light-emitting diode should be under 1 mm as well in order to induce light from LEDs into the light-guide plate. For such a small light-emit surface, the high power LEDs (higher than 1 watt) are not implemented. Presently, in a small laptop computer, a plurality of lower power LEDs are formed in an array and serve as a light bar. Then light from the light bar is broadside emitted into and through the end surface so as to form the light-guide plate.

With reference to FIG. 1, which illustrates a schematic 3-D view of an LED backlight module in prior arts, wherein a light bar 11 is composed of a plurality of edged-emitting LEDs 13 and disposed at the side of a light-guide plate 12. Further that, there are some more drive circuits, control circuits, heat sink devices, etc., but not shown in FIG. 1. The linear light source, as a light bar, of the LEDs 13 functions to emit light into the light-guide plate 12. The present edged-emitting LED is shown as FIG. 2.

With reference to FIG. 2, which illustrates a perspective view of the LED 13 employed to the light bar of FIG. 1. The LED 13 includes a chip 131 and a light-emit window 132 around the chip 131. The dimension of the light-emit window 132 determines the opto-couple efficiency for the light-emit window 132 to the light-guide plate 12. If the thickness of the light-guide plate 12 is 0.5 mm, the width of the light-emit window 132 should not be greater than 0.5 mm, otherwise the opto-couple efficiency will be lower. Accordingly, the dimension of the chip in the LED should be smaller than 0.5 mm. Presently, the dimension of a LED lower than 0.1 W being roughly 0.2 mm is implemented when manufacturing backlight modules. Therefore, the chip of a high power LED (above 1 W) having a dimension of roughly 1 mm cannot be implemented in a small window.

In a light-guide plate of relatively small thickness, a plurality of low power LEDs are applied as a light source. For example, a laptop computer with a 14-inch screen, 64 units of low power LEDs are required. The following problems are arisen when several low power LEDs are used and listed as of (1) uneven in the color, thereby providing uneven light color in the backlight module; (2) each LED providing uneven luminous flux so as to cause uneven brightness in the backlight module; (3) the tint and brightness of each LED being worse after using for a while; (4) any broken LED causing the condition of uniform and shortening the service life; (5) sorting the LEDs for application resulting in increase of the manufacturing expense of an LCD device; (6) testing operation conducted onto each of the LEDs during the production bringing about labor waste and time-consuming.

With reference to FIG. 3, which illustrates a schematic exploded view of the backlight module in prior arts, wherein an LED 23 is utilized as a light source, a light-guide bar 21 is disposed at one side of the light-guide plate 22, and a reflective plate 24 is wrapped around the light-guide bar 21. One or two sides of the light-guide bar 21 must be formed with a plurality of grooves 211. Light emitted from the LEDs 23 enters into the light-guide bar 21 and is guided onto the reflective plate 24 by the grooves 211 firstly, the reflective plate 24 continuously reflects the light into the incident surface 221 of the light-guide plate 22. Under the consideration for providing high light-guide efficiency, the thickness of the reflective plate 24 should be greater than that of the light-guide bar 21. Therefore, the thickness of the cross-section of the equivalent linear light source should be greater than the thickness of the light-guide bar 21. In practice, as an example, when a high power LED is implemented, the light-guide bar 21 should have a thickness of above 5 mm, thus the thickness of the reflective plate should be at least 5 mm. On the other hand, the thickness of the light-guide plate is restricted within 1 mm, the opto-couple efficiency will be very low.

### SUMMARY OF THE INVENTION

It is the objectives of the present invention to provide a backlight module for use in an LCD device so as to eliminate the problems encountered during use of the prior backlight module.

The backlight module of the present invention uses a single or two high power LEDs to provide the efficiency as aforesaid efficiency of the plurality of low power LEDs in prior arts. Since only a single or two LEDs are implemented, there is no occurrence of uneven color or brightness distributed in the light-guide plate. The tint and brightness of each LED being worse after using for a while can be avoided as well. To sort LEDs may not be necessary. Further that, due to that of using one or two LEDs, the defect rate will be lowered and the service life will be elongated.

The LED backlight module of the present invention comprises: a light-guide plate having a light-emit surface; and a light-guide bar being extended from one side of the light-guide plate; wherein the thickness of the light-guide plate is smaller than the diameter of the light-guide bar, the light-guide bar has at least one incident inlet, and a high power LED module is disposed and corresponds to said incident inlet; wherein light from a single LED enters into the light-guide bar via the incident inlet, then the light is totally internal reflected, and partial light is introduced into the light-guide plate firstly, other light is guided into the light-guide plate gradually while the other light is propagating curled in the light-guide bar by way of total internal reflection, therefore the light is guided into the whole light-guide plate along z-axis so as to form the slim backlight module with good uniformity.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrates a schematic 3-D view of an LED backlight module in prior arts;

FIG. 2 illustrates a perspective view of the LED employed to a light bar of FIG. 1;

FIG. 3 illustrates a schematic exploded view of the backlight module in prior arts;

FIG. 4 illustrates a schematic 3-D view of a first preferred embodiment of the present invention;

FIG. 4A illustrates a cross-section view of a profile AA′ of the first preferred embodiment of the present invention;

FIG. 5 illustrates a schematic view of the light-guide bar being tapered from the left end to the right end thereof;

FIG. 6 illustrates a schematic 3-D view of a second preferred embodiment of the present invention;

FIG. 7 illustrates a schematic 3-D view of a third preferred embodiment of the present invention;

FIG. 8 illustrates a histogram for the relationships of the strength of the light from two different LEDs and the locations on the light-guide bar of the present invention;

FIG. 9 illustrates a schematic 3-D view of a fourth preferred embodiment of the present invention; and

FIG. 10 illustrates a schematic 3-D view of a fifth preferred embodiment of the present invention.

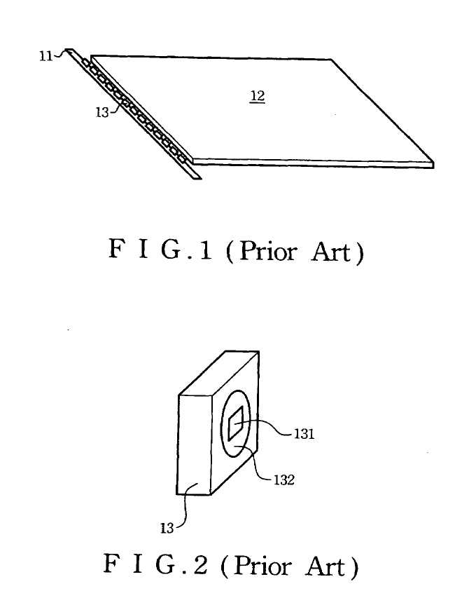

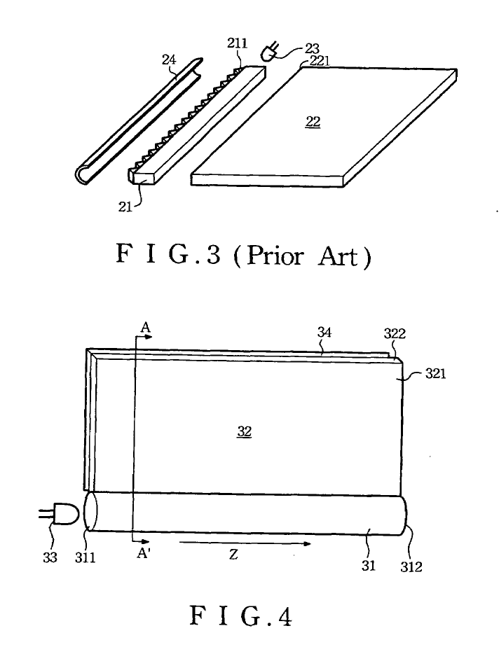

### DETAILED DESCRIPTIONS OF THE PREFERRED EMBODIMENTS

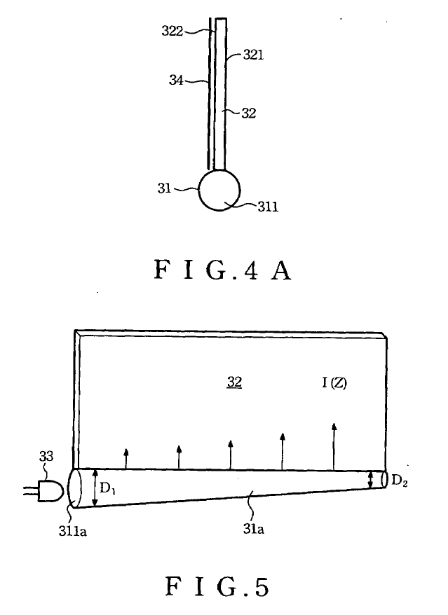

With reference to FIG. 4 and FIG. 4A, which illustrate a schematic 3-D view of a first preferred embodiment of the present invention and a cross-section view of a profile AA′ of the first preferred embodiment of the present invention, wherein the LED 33 can be selected from the group of a white LED and a combination of red, green and blue LEDs. The LED backlight module includes a light-guide plate 32 having a light-emit surface 321 and a light-guide bar 31 with a high transparent material, one side of the light-guide plate 32 is along the z-axis of the light-guide bar 31, and the light-guide plate 32 and the light-guide bar 31 are integrated as one member.

The light-guide bar 31 and the light-guide plate 32 are made of high transparent materials, and the light-guide plate 32 has a refraction index similar to or the same as that of the light-guide bar 31. A high precise mold can be used for molding the light-guide plate 32 and the light-guide bar 31 as one member. Alternatively, disposing transparent glue in between the light-guide plate 32 and the light-guide bar 31 is capable of connecting the two independent plastic members, continuously curing and fusing the transparent glue with same reflective index as light-guide plate by way of ultraviolet rays. The thickness of the light-guide plate 32 is smaller than the diameter of the light-guide bar 31. For instance, an LED of 1-3 watt with the light-emit surface of about 5 mm can cooperate with a light-guide bar with the diameter of about 5 mm, and the thickness of the light-guide plate shall be 0.5 mm properly. The light-emit surface 321 and the rear surface 322 of the light-guide plate 32 can be additionally installed a microstructure, which is selected from the group of a plurality of scatterers, microlens structures and V-shaped grooves. The outside of the rear surface 322 further includes a reflective plate 34 disposed in order to reflect light-guided from the microstructure back to the light-emit surface 321.

The cross-section of the light-guide bar 31 is either cylindrical or polygonal and has a smooth surface without any scattered groove. Light from the light-guide bar 31 are completely guided into the light-guide plate 32. The light-guide bar 31 has at least one incident inlet 311, a high power LED module is disposed at the light-guide bar 31 and corresponds to the incident inlet 311. Regarding to the embodiment, the left side of the light-guide bar 31 serves as the incident inlet 311 and is a total transmissive surface, and the end surface of the other end is a total reflection surface or is coated with a total reflective film so as to let residue light not guided into the light-guide plate be reflected to the light-guide bar. Light from the LED 33 enters into the light-guide bar 31 and travels in the light-guide bar 31 by way of total internal reflection, and partial light is introduced into the light-guide plate 32 firstly, other light is guided into the light-guide plate gradually while the other light is propagating curled in the light-guide bar by way of total internal reflection, therefore the light is guided in the whole light-guide bar 31 along z-axis, and therefore the light in the light-guide bar 31 can be guided into the light-guide plate 32 uniformly. In other words, due to the smooth surface of the light-guide bar 31, the partial light emitted from the LED 33 is guided toward to the light-guide plate 32, other is reflected back and forth along the surface of the light-guide bar 31, which means, there is no way out in the light-guide bar 31, but only the way to the light-guide plate 32. Then a structure with effective opto-couple efficiency is provided.

The light-emit surface 321 and the rear surface 322 of the light-guide plate 32 can be additionally installed with a microstructure, which is selected from the group of a plurality of scatterers, microlens structures and V-shaped grooves. The outside or peripheral of the rear surface 322 further installs at least one reflective plate. Under the construction, the light entering into the light-guide plate 32 from the light-guide bar 31 can be totally reflected back into the light-guide plate 32. Partial light may reach the microstructure of the light-emit surface 321 or the rear surface 322, and the partial light may go out of the light-emit surface 321 or be reflected to the light-emit surface 321 by reflective plates; other light may reach the boundary first and be totally reflected back to the light-guide plate 32 for reusing, wherein some of the other light is introduced back into the light-guide bar 31, then going back to the light-guide plate 32 by means of the light-guide bar 31. So that like an optical resonant cavity is provided by the cooperation of the light-guide bar 31 and the light-guide plate 32.

The aforesaid structure is simulated by computer in the fields of uniformity and utility rate of light, which are upgraded. Simultaneously, it confirms that a larger light-emit surface of the high power LED can be used for guiding the light into the relatively thin light-guide plate.

The cross-section of the light-guide bar 31 shown in FIG. 4 is either cylindrical or polygonal, and such structure may cause that the light transmission intensity will be gradually decreased along the Z-axis. In another word, the light transmission in the light-guide plate 32 is decreased gradually from the left end to the right end of the light-guide plate 32. In order to uniform the light out from the light-emit surface 321, the density of the microstructure in the light-guide plate 32 is increased gradually from the left end to the right end. Another solution is to alter the diameter of the light-guide bar 31, such that the diameter of the light-guide bar 31 is gradually tapered from the left end to the right end so as to homogenize light emitted along z-axis, as shown in FIG. 5.

With reference to FIG. 5, which illustrates a schematic view of the light-guide bar being tapered from the left end to the right end thereof. The LED 33 is disposed around the incident inlet 311a of the light-guide bar 31a, and the diameter of the light-guide bar 31a is gradually smaller from the incident inlet 311a to the other end of the light-guide bar 31a, i.e. D2<D1. In other words, the diameter of the light-guide bar 31a is gradually decreased from the left end to the right end. Under a certain suitable arrangement of D2 and D1, the light strength I(Z) guided through the light-guide plate 32 can be homogenized along z-axis. According to abovementioned structure, the light from the high power LED 33 can be effectively coupled (nearly 90%) into the light-guide plate 32.

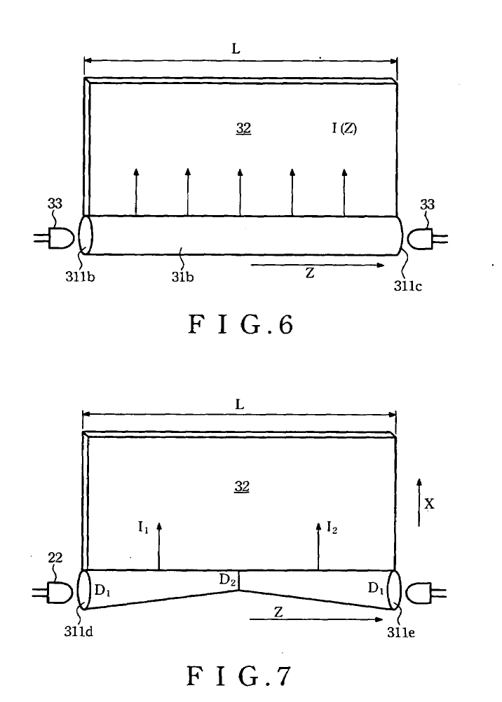

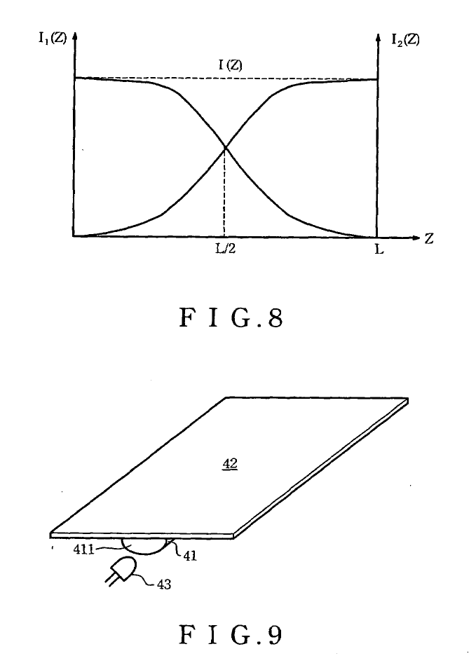

With reference to FIG. 6, which illustrates a schematic 3-D view of a second preferred embodiment of the present invention, wherein the two LEDs 33 are respectively disposed at the two incident inlets 311b and 311c of the light-guide 31b, the light-guide plate 32 and the light-guide bar 31b are connected along z-axis. The light-guide bar 31b is coupled to the light-guide plate 32 along the Z-axis. Due to that of light entering into the light-guide bar 31b symmetrically, therefore the strength I(Z) of the light introduced into the light-guide plate 32 shall be more even than others, such as the first preferred embodiment. For achieving the uniform light strength I(Z), the light introduced into the light-guide bar 31b from the left end therefore can be designed as that of the strength of the light being decayed 50% at the location of L/2. Therefore, the total strength of the light from the left end and the right end at the location of L/2 will be around 100%. But, when the light from the left LED 33 reaching the right end surface B, the residue strength of the light is 25% will be absorbed by the right LED 33, thereby resulting in waste of power light. Therefore another structure is generated as shown in FIG. 7, which illustrates a schematic 3-D view of a third preferred embodiment of the present invention. With reference to FIG. 7, the diameter D2 of the middle (L/2) of the light-guide 31C is smaller than each of the diameters D1 of the two incident inlets 311d and 311e so as to let the strength I₁(Z) and the strength I₂(Z) of the light respectively emitted from the left LED 33 and the right LED 33 be compensated each other, as shown in FIG. 8.

With reference to FIG. 8, which illustrates a histogram for the relationships of the strength of the light from two different LEDs and the locations on the light-guide bar of the present invention, wherein the light strength I₁(Z) is rather uniform where Z<L/2, and decays swiftly upon reaching the middle position, Z=L/2, and approaches to Zero upon reaching the position, Z=L. In the same manner, the light strength I₂(Z) emitted from the right side is symmetric to I₁(Z). Therefore, the total light strength from the left and right sides is nearly uniform within the light-guide plate. However, for each of the LEDs 33, the remaining light strength at the distal end is reduced greatly, thereby providing a higher opto-couple efficiency to the light-guide plate. The light-guide plate requires variation in different densities of micro scatterers along X-axis in order to overcome the non-uniform light strength in the light-guide plate. Since such art is well know in the related field, a detailed description thereof is omitted for the sake of brevity.

With reference to FIG. 9, which illustrates a schematic 3-D view of a fourth preferred embodiment of the present invention, in which, the light-guide plate 42 is firmly disposed on a certain section of the peripheral of the light-guide bar 41. Such that, the light-guided in the light-guide bar 41 may be introduced into the light-guide plate 42. The principle of the fourth preferred embodiment is the same as the first preferred embodiment, as shown in FIG. 4. In the first preferred embodiment, a vertical member, the reflection plate 34 is in front of light-guide plate 32.

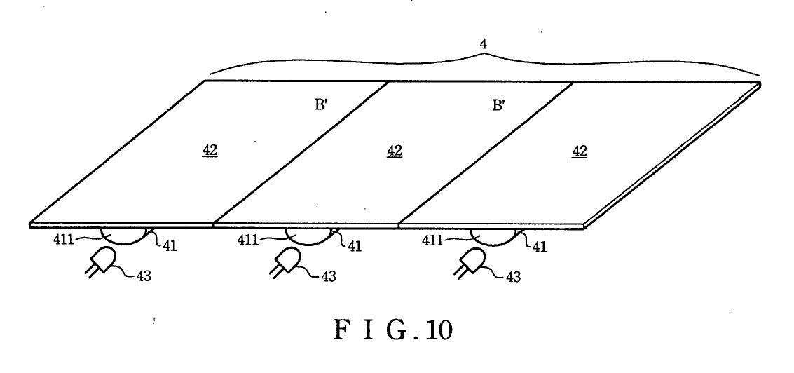

With reference to FIG. 10, which illustrates a schematic 3-D view of a fifth preferred embodiment of the present invention, that is, the plurality of structures as shown in FIG. 9 are assembled to become the structure of the fifth preferred embodiment. Hence, a relatively large light-emit plate 4 can be achieved and the fifth preferred embodiment includes the plurality of LEDs 43, the plurality of light-guide bars 41 and the plurality of light-guide plates 42. The light-guide plates 42 are cooperatively formed the relatively large light-guide plate 4. The light-emit surface of each light-guide plate 42 can be further installed with a diffusion plate in order to homogenize a plurality of boundaries B′. By utilizing the combined structure, a large backlight module can be constructed for a compact TV set having a tremendously large and thin LCD panel. A total of 16 light-guide plates can be used to form a 42″ LCD panel having a length of 52 cm and a width of 6.0 cm, in which a 5-watt LEDs is guided into both sides of each of the light-guide bars. Assuming that the diameter of the light-guide bar is 5 mm, the light-guide plate has a thickness of roughly 1 mm, and therefore the total thickness of the large light-guide plate 4 can be designed within 1 cm. In contrast, if a CCFL (Cold Cathode Fluorescent Lamp) is implemented instead of the LED, the large light-guide plate 4 may have the total thickness of roughly 6 cm.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An LED backlight module comprising:
a light-guide plate having a light-emit surface, and any surface of the light-guide plate parallel to the light-emit surface having a microstructure; and
a light-guide bar with a smooth surface being extended from one side of the light-guide plate;
wherein the light-guide bar has at least one incident inlet, an LED module is disposed at the light-guide bar and corresponds to said incident inlet.

2. The LED backlight module according to claim 1, wherein the cross-section of said light-guide bar is selected from the group of cylindrical and polygonal.

3. The LED backlight module according to claim 1, wherein said light-guide plate and said light-guide bar are integrated as one member.

4. The LED backlight module according to claim 1, wherein said light-guide plate and said light-guide bar are independent, and transparent glue is disposed between said light-guide plate and said light-guide bar, and said light-guide plate has a refraction index similar to that of said light-guide bar.

5. The LED backlight module according to claim 1, wherein said light-guide bar is gradually tapered from said incident inlet to the other end of the light-guide bar.

6. The LED backlight module according to claim 1, further comprising a reflective plate, which is disposed on the surface of the light-guide plate parallel to said light-emit surface.

7. The LED backlight module according to claim 1, wherein the incident inlet of said light-guide bar is a total transmissivity surface, and the end surface of the other end is a total reflection surface so as to let residue light not guided into the light-guide plate be reflected to the light-guide bar.

8. The LED backlight module according to claim 1, wherein at least one reflective plate is disposed at the side of the light-guide plate.

9. The LED backlight module according to claim 1, wherein said microstructure is selected from the group of a plurality of scatterers, microlens structures and V-shaped grooves.

10. An LED backlight module comprising:
a light-guide plate having a light-emit surface and any surface of the light-guide plate parallel to the light-emit surface having a microstructure; and
a light-guide bar with a smooth surface being extended from one side of the light-guide plate;
wherein the light-guide bar has two incident inlets, two LED modules are disposed at the light-guide bar and corresponds to each of said incident inlet.

11. The LED backlight module according to claim 10, wherein the cross-section of said light-guide bar is selected from the group of cylindrical and polygonal.

12. The LED backlight module according to claim 10, wherein said light-guide plate and said light-guide bar are integrated as one member.

13. The LED backlight module according to claim 10, wherein said light-guide plate and said light-guide bar are independent, and transparent glue is disposed between said light-guide plate and said light-guide bar and has a refraction index similar to that of said light-guide plate and said light-guide bar.

14. The LED backlight module according to claim 10, wherein said light-guide bar is gradually tapered from said two incident inlets to the middle portion of the light-guide bar.

15. The LED backlight module according to claim 10, further comprising a reflective plate, which is disposed on the surface of the light-guide plate parallel to said light-emit surface.

16. The LED backlight module according to claim 10, wherein at least one reflective plate is disposed at the side of the light-guide plate.

17. The LED backlight module according to claim 10, wherein said microstructure is selected from the group of a plurality of scatterers, microlens structures and V-shaped grooves.
